(19) United States
(12) Patent Application Publication
(10) Pub. No.: US 2012/0249922 A1
(43) Pub. Date: Oct. 4, 2012

(54) Liquid Crystal Display and Backlight Module Thereof

(75) Inventors: Kuang-Yao Chang, Shenzhen City (CN); Jianfa Huang, Shenzhen City (CN)

(73) Assignee: SHENZHEN CHINA STAR OPTOELECTRONICS NEW DISTRICT, Shenzhen City, Guangdong (CN)

(21) Appl. No.: 13/260,368

(22) PCT Filed: Jun. 1, 2011
(86) PCT No.: PCT/CN2011/075129

§ 371 Date: Sep. 25, 2011

(30) Foreign Application Priority Data
Mar. 31, 2011 (CN) 201120092200.6

(51) Int. Cl. G02F 1/1335; G09F 13/18

(52) U.S. Cl. 349/62; 362/611; 362/613

(57) ABSTRACT

A backlight module is disclosed in the present invention. The backlight module comprises a light guide plate and a light source. The light guide plate comprises a light incident surface, and the light source is disposed adjacent to the light incident surface. The backlight module further comprises a protruding part, which abuts against the light incident surface to define a distance between the light source and the light incident surface. The present invention further discloses a liquid crystal display (LCD) device, which is provided with the aforesaid backlight module. Because the backlight module of the present invention is provided with a protruding part that effectively defines a distance between the light source and the light incident surface of the light guide plate, the light coupling efficiency of the backlight module is remarkably optimized.

### TECHNICAL FIELD

The present invention generally relates to the field of display technologies, and more particularly, to a liquid crystal display (LCD) device and a backlight module thereof.

### BACKGROUND

An LCD device usually comprises a backlight module and an LCD panel superposed on each other. The LCD panel cannot emit light by itself, so the backlight module must be used to provide backlight for the LCD panel. As a kind of typical point light source device, light emitting diodes (LEDs) are often used in the backlight module as a kind of key component. A common practice is to arrange a plurality of LEDs in the form of a point light source array on the surface of a printed circuit board (PCB) to form an LED light bar, and the LEDs are driven by the PCB to emit light to form a bar-shaped line light source. Then, by means of a light guide plate (LGP) of the backlight module, an exiting direction of the light is changed to obtain a uniform surface light source.

Light emitting surfaces of the LEDs are generally close to the light guide plate, and a distance between the LEDs and a light incident surface of the light guide plate has an effect on the coupling efficiency of light rays. In the prior art, due to various factors such as tolerances of the PCB and the heat sink as well as expansion of the light guide plate due to heating or water absorption, the distance between the LEDs and the light incident surface of the light guide plate may be improperly defined to cause poor coupling efficiency of light rays from the backlight module.

### SUMMARY OF THE INVENTION

A primary objective of the present invention is to provide a backlight module which can solve the problem that the backlight module of the prior art LCD device has poor light coupling efficiency.

To achieve this objective, the present invention provides a backlight module, comprising a light guide plate and a light source, wherein the light guide plate comprises a light incident surface and the light source is disposed adjacent to the light incident surface, and wherein: the backlight module further comprises a protruding part which abuts against the light incident surface to define a distance between the light source and the light incident surface.

In a preferred embodiment of the present invention, the light source comprises a plurality of point light sources and a printed circuit board (PCB) electrically connected to the plurality of point light sources, the protruding part comprises a plurality of protruding elements spaced apart from the plurality of point light sources.

In a preferred embodiment of the present invention, the plurality of protruding elements abut against the light incident surface.

In a preferred embodiment of the present invention, the backlight module further comprises a light source support, and both the light source and the protruding part are disposed on the light source support.

In a preferred embodiment of the present invention, the protruding part is a screw fixed on the light source support.

In a preferred embodiment of the present invention, the protruding part is a clamping element clamped on the light source support.

In a preferred embodiment of the present invention, the protruding part is an attached element attached to the light source support.

To achieve this objective, the present invention further provides a liquid crystal display (LCD) device, comprising an LCD panel and a backlight module, wherein the backlight module is disposed adjacent to the LCD panel, the backlight module comprises a light guide plate and a light source, the light guide plate comprises a light incident surface, and the light source is disposed adjacent to the light incident surface, and wherein: the backlight module further comprises a protruding part abutting against the light incident surface to define a distance between the light source and the light incident surface.

To achieve this objective, the present invention further provides a backlight module, comprising a light guide plate and a plurality of light emitting elements, wherein the light guide plate comprises a light incident surface and the plurality of light emitting elements are spaced apart from the light incident surface, and wherein: the backlight module further comprises a plurality of protruding elements that are spaced apart from the plurality of light emitting elements and abut against the light incident surface.

To achieve this objective, the present invention further provides an LCD device, comprising an LCD panel and a backlight module, wherein the backlight module is disposed adjacent to the LCD panel and comprises a light guide plate and a plurality of light emitting elements, the light guide plate comprises a light incident surface, and the plurality of light emitting elements are spaced apart from the light incident surface, and wherein: the backlight module further comprises a plurality of protruding elements that are spaced apart from the plurality of light emitting elements and abut against the light incident surface.

The present invention has the following benefits: as compared to the prior art, the backlight module of the present invention is provided with protruding elements to effectively define a distance between the light source and the light incident surface of the light guide plate, so the light coupling efficiency of the backlight module is remarkably improved.

### BRIEF DESCRIPTION OF THE DRAWINGS

The components in the drawings are not necessarily drawn to scale, the emphasis instead being placed upon clearly illustrating the principles of at least one embodiment of the present invention. In the drawings, like reference numerals designate corresponding parts throughout various views, and all the views are schematic.

FIG. 1 shows a schematic cross-sectional view of a preferred embodiment of a backlight module according to the present invention.

FIG. 2 shows a schematic front view of a backlight module shown in FIG. 1.

FIG. 3 shows a simplified schematic view of a preferred embodiment of an LCD device according to the present invention.

### DETAILED DESCRIPTION OF EMBODIMENTS

Reference will now be made to the drawings to describe preferred and exemplary embodiments of the present invention in detail.

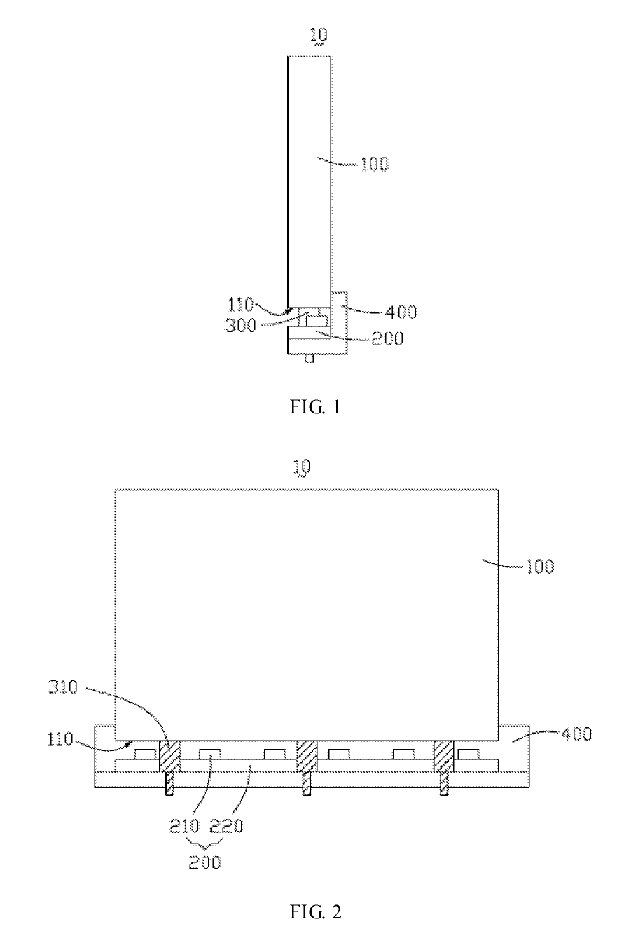

Referring to FIG. 1, the present invention provides a novel backlight module 10, which comprises a light guide plate 100, a light source 200 and a protruding part 300.

The light guide plate 100 comprises a light incident surface 110, and the light source 200 is disposed adjacent to the light incident surface 110. The protruding part 300 abuts against the light incident surface 110 to define a distance between the light source 200 and the light incident surface 110.

Specifically, referring to FIG. 2 together, the light source 200 comprises a plurality of point light sources 210 (e.g., a plurality of LEDs) and a PCB 220 electrically connected to the plurality of point light sources 210. The protruding part 300 comprises a plurality of protruding elements such as screws 310, which are spaced apart from the plurality of point light sources 210 and abut against the light incident surface 110.

In an embodiment of the present invention, the backlight module 10 further comprises a light source support 400. As shown in FIG. 1 and FIG. 2, both the light source 200 and the protruding part 300 are disposed on the light source support 400.

In an embodiment of the present invention, the protruding part 300 is a screw 310 fixed to the light source support 400. As shown in FIG. 2, a stem portion (not shown) of the screw 310 is threaded into the light source support 400, and a screw cap portion (not shown) of the screw 310 abuts against the light incident surface 110 of the light guide plate 100. In a preferred embodiment, the screw cap has a thickened thickness and a widened area to make full contact with the light incident surface 110 of the light guide plate 100. In other embodiments, the protruding part 300 may also be a clamping element clamped onto the light source support 400 or an attached element attached onto the light source support 400.

According to the above descriptions, it can be readily appreciated by those skilled in the art that, the backlight module 10 disclosed in the present invention has protruding elements, which abut against the light incident surface 110 of the light guide plate 100 to effectively define a distance between the light source 200 and the light incident surface 110 of the light guide plate 100. As compared to the prior art where the distance between the LEDs and a light incident surface of the light guide plate is defined by various factors such as tolerances of the PCB and the heat sink as well as expansion of the light guide plate due to heating or water absorption, the distance between the light source 200 and the light incident surface 110 of the light guide plate is only defined by the protruding part; this reduces the number of limiting factors and improves the assembling accuracy, thus resulting in a significantly optimized light coupling efficiency of the backlight module 10. Furthermore, because the protruding elements makes contact with the light guide plate 100 at multiple points, a pin for use in installation as in the prior art is eliminated and the production cost is lowered.

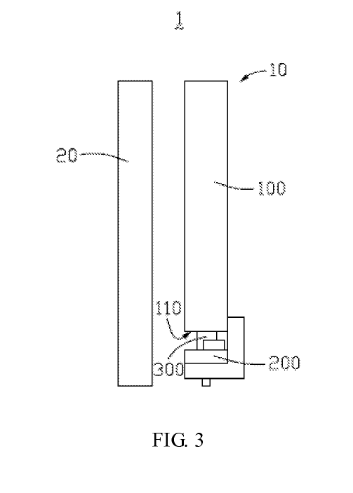

Referring to FIG. 3, the present invention further provides an LCD device 1, which comprises the aforesaid backlight module and an LCD panel 20. The backlight module 10 is disposed adjacent to the LCD panel 20.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A backlight module, comprising a light guide plate and a light source, wherein the light guide plate comprises a light incident surface and the light source is disposed adjacent to the light incident surface, and wherein: the backlight module further comprises a protruding part which abuts against the light incident surface to define a distance between the light source and the light incident surface.

2. The backlight module of claim 1, wherein the light source comprises a plurality of point light sources and a printed circuit board (PCB) electrically connected to the plurality of point light sources, the protruding part comprises a plurality of protruding elements spaced apart from the plurality of point light sources.

3. The backlight module of claim 2, wherein the plurality of protruding elements abut against the light incident surface.

4. The backlight module of claim 1, wherein the backlight module further comprises a light source support, and both the light source and the protruding part are disposed on the light source support.

5. The backlight module of claim 4, wherein the protruding part is a screw fixed on the light source support.

6. The backlight module of claim 4, wherein the protruding part is a clamping element clamped on the light source support.

7. The backlight module of claim 4, wherein the protruding part is an attached element attached to the light source support.

8. A liquid crystal display (LCD) device, comprising an LCD panel and a backlight module, wherein the backlight module is disposed adjacent to the LCD panel, the backlight module comprises a light guide plate and a light source, the light guide plate comprises a light incident surface, and the light source is disposed adjacent to the light incident surface, and wherein: the backlight module further comprises a protruding part abutting against the light incident surface to define a distance between the light source and the light incident surface.

9. The LCD device of claim 8, wherein the light source comprises a plurality of point light sources and a PCB electrically connected to the plurality of point light sources, the protruding part comprises a plurality of protruding elements spaced apart from the plurality of point light sources.

10. The LCD device of claim 9, wherein the plurality of protruding elements abut against the light incident surface.

11. The LCD device of claim 8, wherein the backlight module further comprises a light source support, and both the light source and the protruding part are disposed on the light source support.

12. The LCD device of claim 11, wherein the protruding part is a screw fixed on the light source support.

13. The LCD device of claim 11, wherein the protruding part is a clamping element clamped on the light source support.

14. The LCD device of claim 11, wherein the protruding part is an attached element attached to the light source support.

15. A backlight module, comprising a light guide plate and a plurality of light emitting elements, wherein the light guide plate comprises a light incident surface and the plurality of light emitting elements are spaced apart from the light incident surface, and wherein: the backlight module further comprises a plurality of protruding elements that are spaced apart from the plurality of light emitting elements and abut against the light incident surface.

16. An LCD (liquid crystal display) device, comprising an LCD panel and a backlight module, wherein the backlight module is disposed adjacent to the LCD panel and comprises a light guide plate and a plurality of light emitting elements, the light guide plate comprises a light incident surface, and the plurality of light emitting elements are spaced apart from the light incident surface, and wherein: the backlight module further comprises a plurality of protruding elements that are spaced apart from the plurality of light emitting elements and abut against the light incident surface.
